(19) United States
(12) Patent Application Publication
(10) Pub. No.: US 2008/0015967 A1
(43) Pub. Date: Jan. 17, 2008

(54) Trend Contract

(76) Inventor: Joseph Melville Gilmer, Selma, AL (US)

Correspondence Address: JOSEPH MELVILLE GILMER, JR., 124 MALLORY DRIVE, SELMA, AL, 36701, US

(21) Appl. No.: 11/457,513

(22) Filed: Jul. 14, 2006

(51) Int. Cl. G06Q 40/00

(52) U.S. Cl. 705/37

(57) ABSTRACT

This invention is a financial instrument and method for allowing the market to determine, through pricing, the reliability of a trend as calculated by a corresponding technical analysis indicator. This invention can also be used as a measure of the influence that technical investors or fundamental investors have on the pricing of an item or event of interest.

### CROSS-REFERENCE TO RELATED APPLICATIONS

Not Applicable

### STATEMENT REGARDING FEDERALLY SPONSORED R & D

Not Applicable

### REFERENCE TO SEQUENCE LISTING

Not Applicable

### BACKGROUND OF THE INVENTION

For many years, investors have used either fundamental analysis or technical analysis of investment opportunities to predict the direction of a sustained price movement of a market. This is often referred to as identifying the trend.

Throughout the course of a trading day, both fundamental and technical investors are buying and selling an item of interest. Therefore, the price of an item of interest is influenced by both types of investors. However, it is difficult to determine the amount of influence each type of investor has on the price.

Fundamental investors use a qualitative approach. Supply and demand relationships are analyzed. If there is a perceived supply and demand imbalance, fundamental investors believe that price changes will bring the supply and demand relationship back into equilibrium. These investors see the market as basically efficient and that all current information will be reflected in the market price. Most see each price change as independent of each other price change, with price movement being random and unpredictable. Therefore, these investors do not believe that a perceived price trend will predict future price direction.

Technical investors, however, use mathematical based technical analysis indicators to determine price trends. Various moving averages, oscillators, regression analysis, momentum analysis and adaptive techniques are but a few of the many technical analysis indicators used by those skilled in the art.

Usually, technical investors use price of an underlying item of interest as their input value in a technical analysis indicator calculation. If technical investors feel the indicator has determined the direction of a trend, they will buy or sell the underlying item of interest accordingly in hopes that the price will continue in the direction of the calculated trend. However, these investors are making their decision based on the indicator's calculation, whose value is usually different from the price of the underlying item of interest. Since the indicator's value is calculated using past prices of the underlying item of interest, the indicator's value lags behind the market price of the item of interest.

Since an item of interest's price is influenced by both technical and fundamental opinions and since the technical analysis indicator's value is calculated from the item of interest's price, the indicator's value also reflects both technical and fundamental opinions of price direction. Because of this, a technical investor does not know to what extent the technical analysis indicator is a reflection of technical price opinion or of fundamental price opinion. Therefore, the technical investor has no way of judging the reliability of a calculated price trend generated by a technical analysis indicator.

When the item of interest's price and the corresponding technical analysis indicator's value are moving in the same direction, both technical and fundamental investors are in agreement on the price direction of the item of interest. At other times, the item of interest's price will trade in the opposite direction of the calculated price trend. This divergence indicates disagreement between fundamental and technical investors. For example, if the technical analysis indicator's value reveals an up trend, technical investors would be buying the underlying item of interest so as to follow the trend. But if the market price of the item of interest is moving down, then fundamental investors are selling the item of interest. Furthermore, this indicates that the fundamental investors are dominating the price battle. Once again, since the item of interest's price is being determined by the fundamental investors at this point in time, the technical analysis indicator becomes an unreliable indicator of the price trend.

In addition to analyzing the price of a specific item of interest, investors can also study economic and societal events by examining the activity of an event of interest. Generally, an event's activity is measured in units, quantity, or volume of activity. Some examples of this would be: the amount of an item sold, number of transactions processed, the quantity of an item shipped, tons of an item loaded, gallons of water used, number of policies written, tons of pollution emitted, amount of debt, number of unemployed people, the number of births, income per household, and automobiles sold.

Just as in the analysis of prices, technical and fundamental analysis can be used to determine the direction of an event by analyzing the event's activity. Once again the question arises: does an event's trend continue or end because participants get in or out due to a perceived trend, or is there some underlying fundamental factor affecting the event's activity one way or the other? Or do both technical and fundamental opinions influence the event's activity, and if so, to what extent?

### BRIEF SUMMARY OF THE INVENTION

The present invention, a TREND contract, is a method for allowing the market to determine, through pricing, the reliability of a trend as calculated by a corresponding technical analysis indicator. It can also be used as a measure of the influence that technical investors or fundamental investors have on the pricing of an item or event of interest.

The present invention gives investors the opportunity to buy or sell a technical analysis indicator's calculated trend without having to buy or sell the underlying item or event of interest. Prior to this invention, investors must buy or sell an item or event of interest to participate in the trend.

Investors make bids and offers to buy or sell a TREND contract thus reflecting their opinions on the direction of the corresponding technical analysis indicator's calculated trend. When a bid and offer are matched, a trade occurs and a market price for a TREND contract is generated.

Investors can then compare the TREND's market price to the value of the corresponding technical analysis indicator and to the underlying price of an item of interest. Divergence and convergence of these various prices and values will give an indication if technical or fundamental investors are in control of the item of interest's pricing and if the trend indicated by the technical indicator is reliable.

### BRIEF DESCRIPTION OF THE SEVERAL VIEWS OF THE DRAWING

Not Applicable

### DETAIL DESCRIPTION OF THE INVENTION

The following five examples and discussion will present the embodiments of the TREND contract and methods.

Example number 1 represents a stock TREND contract which contains the following components: (a) Underlying item of interest—stock A, (b) Corresponding technical analysis indicator—10 day simple moving average of stock A's price (MASTOCKA), (c) Indicator input data—daily closing price of stock A (PRICESTOCKA), (d) Financial consideration settlement value—the difference between the original purchase or sale price of the TREND and the value of MASTOCKA at the close of trading on the last trading day times the financial consideration adjustment factor, (e) Financial consideration adjustment factor—none, (f) Last trading day—last day of the month for trading of stock A, (g) Settlement date—first business day following the last trading day, (h) Marketplace—TREND traded on a national exchange with bids, offers, trades and market price (MPTRENDSTOCKA) quoted in dollars and cents.

Example number 2 represents an unemployment TREND contract which contains the following components: (a) Underlying event of interest—the unemployed in the U.S., (b) Corresponding technical analysis indicator—3 month simple moving average of the number of unemployed (MAUNEMPLOYED), (c) Indicator input data—the number of unemployed in the U.S. as reported monthly by the Department of Labor (PRICEUNEMPLOYED), (d) Financial consideration settlement value—the difference between the original purchase or sale price of the TREND and the value of MAUNEMPLOYED at the close of trading on the last trading day times the financial consideration adjustment factor, (e) Financial consideration adjustment factor—$1.00, (f) Last trading day—one business day after the date of announcement of the latest monthly unemployment numbers, (g) Settlement date—first business day following the last trading day, (h) Marketplace—TREND traded over the counter with bids, offers, trades and market price (MPTRENDUNEMPLOYED) quoted in number of unemployed.

Stock A and the unemployed in the U.S. are used as examples of an item and event of interest. However, this does not imply that the item and event of interest is limited. It is the intent that all types of items whose market activities can be analyzed with technical analysis techniques are contemplated in this invention. Activities associated with economic and societal events that can be analyzed with technical analysis are also contemplated.

The simple moving average is used as our corresponding technical analysis indicator in the examples. However, this does not exclude the many other technical analysis indicators that can be used with this invention.

The ten day and three month time intervals were used in the moving average calculations. This is for illustrative purposes only. It is not the intent of this invention to limit any technical analysis indicator to a specific time interval.

The financial consideration at settlement is not limited to cash as in these examples. Financial consideration can also be physical goods, various financial instruments and derivatives, contracts for services, and any other item of value used to facilitate daily commerce.

The last trading day and the settlement date used in these examples are for illustrative purposes only. It is not the intent of this invention to limit the last trading day and settlement date to a specific date or time in the calendar.

A buyer and seller will receive or remit financial consideration to each other on settlement date depending on whether the technical analysis indicator value moved in or against their favor by the close of trading on the last day, unless they had liquidated their positions prior to the close of trading. It is intended that settlement of a TREND can be handled by the parties to the contract or by a third party guaranty or clearing organization.

The input data used in these two examples are PRICESTOCKA and PRICEUNEMPLOYED. It is not the intent to limit the input data to these two, but to include any input data that represents a specific aspect or activity of an item or event.

The contract is not limited to trading on a national exchange. It is intended that bids and offers on a TREND contract can be made on or at any public or private venue or platform where these bids and offers can be matched, a trade recorded, and a market price of the TREND generated.

Example number 3 is a mathematical comparison between the MPTRENDSTOCKA, value of MASTOCKA and PRICESTOCKA of Example 1: (a) MPTRENDSTOCKA minus value of MASTOCKA, (b) MPTRENDSTOCKA minus PRICESTOCKA, (c) value of MASTOCKA divided by MPTRENDSTOCKA, (d) PRICESTOCKA divided by MPTRENDSTOCKA, (e) MPTRENDSTOCKA times (PRICESTOCKA divided by value of MASTOCKA). An investor would specify the time frame over which these comparisons would be made.

Example number 4 is a graphical comparison of the MPTRENDSTOCKA, value of MASTOCKA and PRICESTOCKA of Example 1. The MPTRENDSTOCKA, value of MASTOCKA, and PRICESTOCKA values for a time frame specified by an investor are plotted on a graph using the appropriate time and price axis.

Example number 5 is a graphical comparison of the values calculated in Example 3(a thru e). These values for a time frame specified by an investor are plotted on a graph using the appropriate time and price axis.

The number of mathematical and graphical comparisons between the MPTRENDSTOCKA, the value of MASTOCKA, the PRICESTOCKA and various combinations of these variables are not limited to those shown in Example 3, 4 and 5. In addition, these comparisons are not limited to these examples. These comparisons can be made using any TREND contract's market price and its corresponding technical analysis input data and calculated values.

While this invention has been described with specific embodiments in the examples, these examples should be considered in all respects as illustrative and not restrictive. Other alternatives, modifications, and variations will be apparent to those skilled in the art. Therefore, it is intended to include all such alternatives, modifications, and variations set forth within the spirit and scope of the appended claims.

I claim:

1. A financial instrument and method that creates a contractual relationship between a buyer and a seller, granting both parties the right to receive and the obligation to remit financial consideration at some predetermined date. Said financial consideration will be determined as the difference between a buyer's or seller's original purchase or sales price of the financial instrument and the value of a corresponding technical analysis indicator that was calculated from input data representing a specific aspect or activity of the financial instrument's underlying item or event of interest.

2. The financial instrument and method according to claim 1, in which the financial consideration determined value is adjusted by an accounting factor such that the value will be expressed in monetary terms.

3. The financial instrument and method according to claim 1, in which bids and offers can be made to buy and sell the financial instrument on a real time basis and where these bids and offers, when matched, result in a trade and a market price for the financial instrument.

4. The financial instrument and method according to claim 1, in which the contractual relationship is between the buyer or seller and a third party guaranty or clearing organization.

5. A method of comparing the market price of the financial instrument and method according to claim 3, in which the market price of the financial instrument is compared to the calculated value of the financial instrument's corresponding technical analysis indicator.

6. A method of comparing the market price of the financial instrument and method according to claim 3, in which the market price of the financial instrument is compared to the input data used in the financial instrument's corresponding technical analysis indicator calculation.
